(19) United States
(12) Patent Application Publication
(10) Pub. No.: US 2019/0347383 A1
(43) Pub. Date: Nov. 14, 2019

(54) Software Protection Method Based on A License File

(71) Applicant: Ching-Ming Lai, Wakefield, MA (US)

(72) Inventor: Ching-Ming Lai, Wakefield, MA (US)

(21) Appl. No.: 15/978,101

(22) Filed: May 12, 2018

(51) Int. Cl. G06F 21/10; G06F 21/12; G06Q 50/18; G06F 21/44; G06F 17/24; G06Q 20/10

(52) U.S. Cl. CPC G06F 21/105; G06F 21/121; G06Q 50/184; G06F 2221/2137; G06F 17/243; G06Q 20/102; G06F 21/44

(57) ABSTRACT

A method of protecting a software program from unauthorized usage is presented. At startup, the program reads an encrypted license file. The license file contains a license ID number. The program matches the license ID number against the predetermined computer ID number. If they match, the program will run normally. Otherwise, the program closes immediately or runs with limited functionality. The license file is prepared based on the predetermined computer ID number submitted to the vendor website. The program displays the computer ID number for the user to copy-and-paste the number onto a webpage. After making the payment, the user downloads the license file from a webpage and saves the license file into a designated folder.

### FIELD OF THE INVENTION

The present invention relates generally to software protection, and more specifically, to the protection of distributed software from unauthorized usage. The present invention also relates to the method and procedure of establishing an authorization system for software usage on a permanent or temporary basis.

### BACKGROUND OF THE INVENTION

This invention is about a method of protecting a software product from unauthorized usage. Many prior arts have been used in the past. Some prevent the software from being duplicated or reverse-engineered. Some encrypt the software such that certain keys are required to decrypt the software before it can be run on a computer. Some require an encoded hardware device connected to the computer communication port in order to run the software. Some use a one-time qualification process to install the software, such as entering a long valid serial number provided with each copy of the product and allowing the software to run normally without any validation thereafter. The present invention does not use any of these types of protection.

This invention uses an encrypted file that encodes certain values of predefined variables to authorize the usage of the program. This encrypted file is referred to as the license file here. During or after the opening of the program, the program reads this license file and decrypts it to read these values. The program then matches these values against the values read from the computer or the properties associated with the program. If they match, the license file is valid and the program is allowed to run normally. If they do not match, the program will be closed immediately or allowed to perform limited functionality only.

The present invention suggests a simple and reliable procedure for the user to obtain the license file. Once the license file is downloaded and installed, no more action or interaction is needed for the user or the program to maintain the software protection. This invention suggests the program to be installed first. The program then prepares the computer ID number for the user to apply for the license file. This invention suggests a simple method of submitting the computer ID number to the vendor website for preparing the license file. This invention also suggests the same procedure for the user to download a temporary license file free of charge with expiration date. This allows the user to practice the procedure and to evaluate the software product.

### SUMMARY

This invention suggests a method of protecting a software program from unauthorized usage. The software program requires an encrypted license file containing the computer ID number to run normally with full functionality. In the process of purchasing the license file, the user provides the computer ID number to the Internet webpage. To facilitate the process, the software program displays the computer ID number and allows the user to copy it to the computer clipboard. The user can then paste the computer ID number from the clipboard to the webpage input box. Based on the submitted computer ID number, the webpage prepares an encrypted license file and provides a means for the user to download the license file into a designated folder.

### BRIEF DESCRIPTION OF THE DRAWINGS

FIG. 1. The process of getting a permanent license file is illustrated. The user has to input the computer ID number and make payment.

FIG. 2. The process of getting a temporary license file is illustrated. The user also has to input the computer ID number but does not make payment.

FIG. 3. The process of using the license file is illustrated. The program checks the program name, the version number, the computer ID number, the license type, and the expiration date stored in the license file. It then decides to put the program on restriction or allow it to perform as a normal program without restriction.

### DETAILED DESCRIPTION

In this invention, a license file is needed for the software program to run as a normal program. The license file contains a license identification (ID) number. This number is provided by the user in purchasing the license. This number can be the product ID number or serial number of one of the computer hardware components. This number can also be the operation system software product ID or serial number. In any case, one of these numbers is selected to be the license ID number, and referred to as the predefined number in the description here. The program can read and display this number such that the user can provide this number to purchase the license.

In one embodiment of the invention, the license file selects the computer MAC address as the license ID number. The MAC address is associated with the computer network access hardware. It is very much a unique number. In this embodiment, the program displays the MAC address as the computer ID number.

The license file also contains the program name and program version, which is selected by the user in purchasing the license. The license file may also contain the expiration date, purchasing date, and other data. The license is encrypted such that it is hard to edit for other usages.

The program can be downloaded from the vendor website. It can be installed and open in any targeted computer without the license file. But without the license file, the program can only perform certain limited functions. At start-up, the program tries to find and read the license file. After decrypting the license content, the program compares the license ID number against the computer ID number read from the computer. The program also verifies that the program name and version number in the license file is intended for the current program and current version. If everything passes, the program will run as a normal program with full functionality. Otherwise, it can only perform certain limited functions.

The user purchases and downloads the license file for the program from the vendor's website. In the process, the website displays a webpage form and requests the user to input the computer ID number. As describe above, the user can open the program to display the computer ID number. Based on the computer ID number displayed on the program, the user can enter this number manually onto the webpage form. The user can also do copy-and-paste to put this number onto the webpage form. After submitting the form, the user goes through the payment procedure. The webpage server then prepares the license file based on the entered number as the license ID number and provide a webpage for the user to download the license file.

It should be noted the copy-and-paste operation is a common feature provided by the computer operating system. To use this feature, the user selects the text of interest from a window and copy the text to operating system clipboard by pressing the keyboard Ctrl-C key. The user then selects the input box and presses the keyboard Ctrl-V key to paste the content on the clipboard onto the input box. In this case, the text of interest is the computer ID number displayed on the program and the input box is box on the webpage form requesting for the computer ID number. To facilitate this copy-and-paste operation, the program may provide a “COPY” button. The user can simply click this “COPY” button, and the program will copy the computer ID number to the clipboard. The user then paste the clipboard content to the webpage form to complete the operation.

This invention also suggests the license file to include the variable of license type to specify it a temporary or permanent license. The use can download a temporary license file free of charge from the website like the permanent license file, except it does not go through the payment procedure. When the program reads the license file and recognizes it a temporary license type, the program will check the expiration date against current time to accept or reject the license file. The usage of temporary license file allows the user to practice the copy-and-paste procedure of the computer ID number, as well as the download and installation procedure of the license file. It also allows the user to verify the license file is working correctly with the program and make sure the program can perform to full functionality with the license file. More importantly, it allows the user to evaluate the software product for certain period of time before purchasing the license.

The vendor webpage server prepares relevant data for each purchase, such as the purchasing date, the paid price, the license ID number, the license type, the program name and version, the payment reference ID, the number of downloads, and so forth. The server then stores the data of each purchase into a database as a record based on the license ID number as the primary key. If the user download the purchased license file again, the number of downloads in the record will be incremented. The server also prepares similar data for each download of temporary license file without payment and stores the data into a record in another table of the database. When the user downloads the temporary license again, the record will be retrieved from the database based on the computer ID number, which is the license ID number. The number of downloads in the record will be incremented. Therefore, from the database record, the server can limit the number of free downloads from the same license ID number. This prevents repetitive usage of the temporary license file. From the database record, the server can also allow the user to download the purchased permanent license file multiple times. This allows the user to replace the purchased license file free of charge in case the license file get lost or misplaced.

The present invention offers a relative simple procedure to purchase and install the software product with effective protection from unauthorized usage. It is a self-contained and one-time setup protection method. The user only has to interact with the vendor webpage once to purchase the license file. Once the license file is downloaded and installed, the program does not communicate with the vendor website for the protection from unauthorized usage. In fact, the program can run without the Internet connection in the computer. This protection method does not violate computer privacy and Internet privacy.

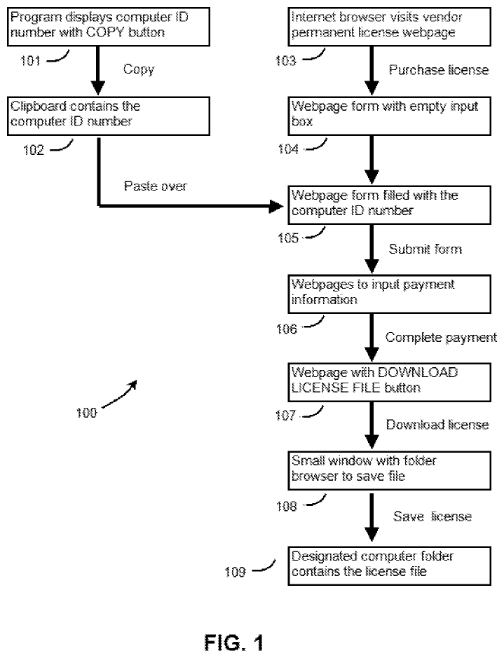

The process of getting a permanent license is further illustrated in FIG. 1. On the one hand, the user opens the program, which reads and displays the computer ID number, as shown in 101. The user copies the computer ID number to the clipboard as shown in 102, by presses the COPY button or selects the computer ID number and press Ctrl-C key. On the other hand, the user visits the vendor website and navigates to the page for purchasing this program's license shown in 103. The user clicks the purchase button, and the webpage returns with a form requesting the computer ID number in 104. The user pastes the computer ID number stored in the clipboard to the webpage form by selecting the input box of the form and pressing Ctrl-V key as shown in 105. The user then submits the form. The webpage returns with tools for the user to provide payment related information shown in 106. The user enters needed data to complete the payment procedure. After verifying and approving the payment, the webpage returns with a button to download the license file in 107. The user clicks the download button. A small webpage appears with a tool for the user to save the license file to a folder in the computer as shown in 108. The user saves the license file into a designated folder specified by the program in 109.

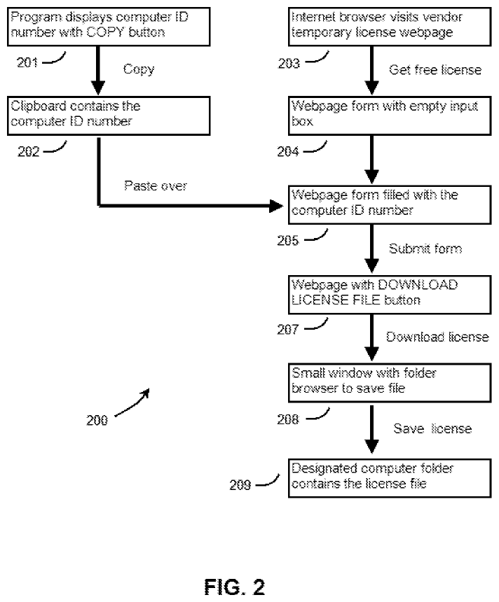

For comparison, the process of getting a temporary license file is illustrated in FIG. 2. It is very similar to that of getting a permanent license file. The steps of 201, 202, 204, 205, 207, 208, and 209 are the same as the steps 101, 102, 104, 105, 107, 108, and 109. The difference is in step 203, in which the user browses to a webpage of downloading a temporary file instead of a permanent file in 103. Above all, the step of making payments in 106 is missing here. Then, of course, the license file is prepared as a temporary type which cares about the expiration date.

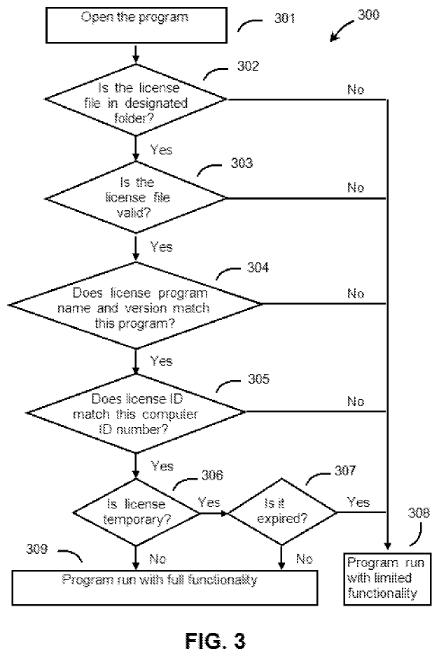

The process of using the license file is further illustrated in FIG. 3. When the user opens the program in 301, the program checks to see if the license file exists in the expected folder in 302. If the file exists, it reads the file and decrypts to see if it contains valid data in 303. Otherwise, the program has been restricted to perform only limited functions. If the license file is authentic, it checks the program name and version number contained in the license file in 304. Otherwise, the program is restricted. If they match the current program name and version, it checks the license ID number contained in the license file in 305. Otherwise, the program is restricted. If it matches this computer ID number, it checks the license type in 306. Otherwise, the program is restricted. If the license type is temporary, it checks whether the current time exceeds the expiration date in 307. If the license has expired, the program is restricted as shown in 308. If the license has not expired or the license type is permanent, the program runs as the normal, unrestricted program with full functionality.

In the description above, the license file controls the software product to be fully restricted or not. But a large software product may contain many modules to perform many distinct tasks and features. The vendor may want to offer the product at different levels of restriction. The present invention can do that. In one embodiment of this invention, another variable of say “license class” is included in the license file. The value of license class is selected by the user at the time of purchasing the license. Based on the value of license class, the program can restrict the usage of the product at different levels.

The number of variables contained in the license file is relatively small. To make them hard to decode by hackers, these variables are mixed with large amount of random numbers to prepare the license file at large size. In this invention, to deter the hackers further, each of these variables are dispersed into the large license file depending on a random number read from a predetermined and secret location of the license file. Therefore, each time a license file is prepared, these variables are dispersed into different locations of the license file. When the program read the license file, it first reads the random number from the predetermined and secret location after license file is decrypted. Based on the random number and the known algorithm, the program retrieves the values of these variables to perform the protection task.

The success and merit of the protection system relies on secrecy and a good algorithm for encrypting the license file. A key is needed to encrypt the data. Instead of following the common practice of using a constant encryption key, a random key is used to provide better protection. In this invention, a secret small section of the license file is reserved to store only random numbers without encryption. When the license file is prepared, certain random numbers at secret locations within this section are used to encrypt the rest of the license file. When the program reads the license file, it first reads the random numbers within this secret small section from the license file without decryption. It then uses these random numbers at secret locations known to the program as the key to decrypt the rest of the license file.

The essence of the software protection in this invention is the usage of an encrypted license file. In the description above, the license file is prepared server-side by the vendor website. In fact, the license file can be generated in the same manner by a computer anywhere as long as the same algorithm is used and the necessary license-generating parameters are provided. In some situations, the preparation and download of the license file through the vendor website as described above may not be the preferred practice. For example, if the software is pre-installed and shipped with the computer, it may be preferred to deploy the license file pre-installed. In such cases, it is better to prepare and install the license file via the pre-installed program itself. Of course, some authorization means, such as password protection, could be imposed to enable the license file generation by the program. Thus, in another embodiment of the invention, the license file is generated by a computer anywhere using the proposed encryption algorithm and associate data, especially by the software program to be protected, upon the granting of authorization.

The preferred authorization method is for the program to make a request to the vendor website and submit certain data, such as the computer ID, without browsing a webpage. In this embodiment, the vendor web server checks the Internet Protocol address of the client computer and possibly validating additional submitted data, e.g. computer name and password, to determine if the request is qualified. If it is qualified, the authorization is granted by responding the request with a “Yes” flag. The event may be saved into a record in the vendor website database containing the computer ID, Internet protocol address, and other relevant data for future reference. If it is not qualified, the authorization is rejected by responding to the request with a “No” flag. Based on the granted authorization in this manner, the software program can proceed to generate the license file.

In many of the prior arts, such as U.S. Pat. No. 9,633,183, “Modular Software Protection”, and U.S. Pat. No. 6,944,601, “Method of Licensing Software Programs”, the protection relies on a license key to unlock the software. The license key is a long and unique number, like a credit card number, known only to authorized users. The user has to provide the license key to the software by some means and may have to store it somewhere. For comparison, the license key in this invention is the computer ID, which is known to any user. But the license key can only read into the program from the license file. The protection of this invention relies on the secret encoding and encryption to hide the license key and prevent it to be fabricated by hackers. The license file is self-contained. Once the license file is obtained and installed, the user does not have to do anything.

Some prior arts, such as the patent of U.S. Pat. No. 6,463,538, “Method of Software Protection Using a Random Code Generator” and the patent of U.S. Pat. No. 7,890,430, “Technique for License Management and Online Software License Enforcement”, the protection relies on adding special component to the software or encrypt the software. In some cases, the software is individualized in which the software contains different codes for different user. This adds the complexity to the software product. On the other hand, the software in this invention remains the same as it has been compiled and built. The software is identical to every user. This simplifies the software production and distribution.

It should be noted that some prior arts, such as U.S. Pat. No. 6,044,469, “Software Publisher or Distributor Configurable Software Security Mechanism”, may also use a license file in the protection system. However, such license files are used under different context and for different purpose. Usually, they are used to store information related to license management, license agreement, license rules, and so forth. Unlike the present invention, these license files are not used to store a license key to unlock the software. It should also be noted that some prior arts, such as U.S. Pat. No. 8,538,889, “Application Hierarchy and State Manipulation”, a software protection system is used but it is not the subject of the invention.

Some prior arts, such as the patent of U.S. Pat. No. 7,890,430, “Technique for License Management and Online Software License Enforcement”, the software protection includes a method and system of managing and enforcing the software usage according the restrictions and rules of the purchased license. In this invention, such functions are controlled by the license class specified in the license file as described earlier. For this purpose, this invention is self-contained and it avoids the complexity of including a license management system.

As described above, this invention provides a simple and reliable protection system. Other than the license file, it does not use any hardware or software components. It allows the user to evaluate the product first and then purchase the license as simple as purchasing any software product online. After the license file is installed, no action is needed from the user and no communication takes place between the software and the vendor website. This invention also makes the production and distribution of the software product as simple as those without any protection system. This invention has been tested in the field with the expected satisfaction.

What is claimed is:

1. A software program protection method comprising:
a vendor webpage form to receive user computer ID number as the license ID number; and
a license file prepared in the vendor website based on the computer ID number and encrypted; and
a webpage for the user to download the license file into a designated folder in the user computer; and
a software function in the program to read and decrypt the license ID number in the license file and restrict the program to perform limited functionality if the said license ID number does not match the computer ID number read from computer system.

2. The said software program in claim 1 generates and displays the computer ID number for the user to read and submit it to get the license file.

3. The said software program in claim 1 provides a ‘COPY’ button for the user to click and thus copy the computer ID number to the computer clipboard.

4. In the said vendor webpage form in claim 1, the user can type in the computer ID number directly into the webpage input box and submit the webpage form.

5. In the said vendor webpage form in claim 1, the user can paste the computer ID number from the clipboard onto the webpage input box and submit the webpage form.

6. In the said vendor webpage form in claim 1, the computer MAC address is used as the computer ID number.

7. In the said software function in the program in claim 1, it also reads the program name and version number in the license file and restricts the program to perform limited functionality if they do not match this program's name and version number.

8. In the said software function in the program in claim 1, it also reads the license type and expiration date in the license file and restricts the program to perform limited functionality if the license type is temporary and the current time exceeds the expiration date.

9. The vendor website stores the purchasing record into a database and uses it to keep track and prevent repetitive downloads of temporary license file from the same computer ID number.

10. In the said software function in the program in claim 1, it also reads the license class variable in the license file and restricts the usage of the program at different levels according to value of the license class.

11. The variables of the license file, such as the computer ID, the program name, the version number, the license type, the expiration date, and the license class, are mixed with large amount of random numbers to prepare a large license file, and these variables are dispersed into the license file according to certain random numbers stored in certain secret locations of the license file.

12. A small section of the license file containing only random numbers is not encrypted and certain random numbers located within this section is used as the keyword to encrypt the rest of the license file.

13. The said license file is generated by a computer anywhere using the required encryption algorithm and associate data, especially by the software program to be protected, upon the granting of authorization.

14. In the said authorization in claim 13, the program makes a request to the vendor website for authorization and the web server grants authorization based on the criteria of the Internet Protocol address of the requesting computer and any additional submitted data.
